(19) United States
(12) Patent Application Publication
(10) Pub. No.: US 2009/0244316 A1
(43) Pub. Date: Oct. 1, 2009

(54) AUTOMATIC WHITE BALANCE CONTROL

(75) Inventor: Willem Johan De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/721,680

(22) PCT Filed: Dec. 19, 2005
(86) PCT No.: PCT/IB2005/054304

§ 371 Date: Jun. 14, 2007

(30) Foreign Application Priority Data
Dec. 22, 2004 (EP) 04106888.3

(51) Int. Cl. H04N 9/73

(52) U.S. Cl. 348/223.1; 348/E05.024

(57) ABSTRACT

A system for performing automatic white balance (AWB) control in which the limited white area (200) is clearly defined by a formula which fits exactly to the black body radiator curve (202) in at least two domains, the formula being a function of those two domains. The function is then offset to the left and/or right to define the limited white area (200) around the black body radiator curve (202). No calibration at the time of manufacture is required, and no permanent memory to store respective parameters and measurements for automatic white balancing is necessary. The resultant limited white area (200) can be used provided a color matrix is employed beforehand, in order to transform the color space of the image sensor to a known color space. In this known color space, the exact location of the black body radiator curve is known, and therefore the above-mentioned formula can be used to form the LWA detection region around it.

This invention relates generally to automatic white balance control, for example, in color digital cameras or image processing software packages and, more particularly, in which a so-called limited white area is defined within the color space wherein only pixels within the limited white area are taken into account for automatic white balance control.

In a color digital camera, white balance is achieved when a neutral white object imaged by the camera under given illumination is represented as red (R), green (G) and blue (B) signals having equal output levels. White balance is needed since the RGB representation produced by a color video camera, say, typically changes as the illumination of a scene varies. In some circumstances, a color video camera white balanced for certain illumination conditions will not be white balanced for other illumination conditions. As a result, it is possible that an object under two different illuminations will have two different RGB representations, even though a human observer would perceive the object as having the same color under both illuminations.

In a manual operation, white balance is achieved by imaging a neutral white object under the illumination of interest and adjusting the amplification of one or more of the red, green and blue signals until their respective output levels are equal. In an automatic white balance (AWB) operation, a neutral white object under the illumination of interest is imaged and the amplification levels of each of the red and blue signals are adjusted automatically. For example, the output levels of the red and blue signals may be made equal to that of the green signal.

Conventional AWB circuits tend to control to R=G=B=1, which corresponds to a certain preset white, and in respect of these circuits, it is known to use a so-called “limited white area” (LWA), which is a certain defined area in a two-dimensional color space, which is used to determine if a color is “near white”. Since the human brain can adapt itself to various lighting conditions, be it either daylight, bulb light, or anything in between, the human brain considers a real white object under all of these lighting conditions as white. So the definition of “near white” can be considered to be all light sources between daylight and bulb light. Conventional AWB circuits include each pixel's RGB value in the average white measurement. This system is known as the World Grey Assumption (WGA). Such a system assumes that the separate average of the R, G and B values of all pixels in an arbitrary scene will result in white.

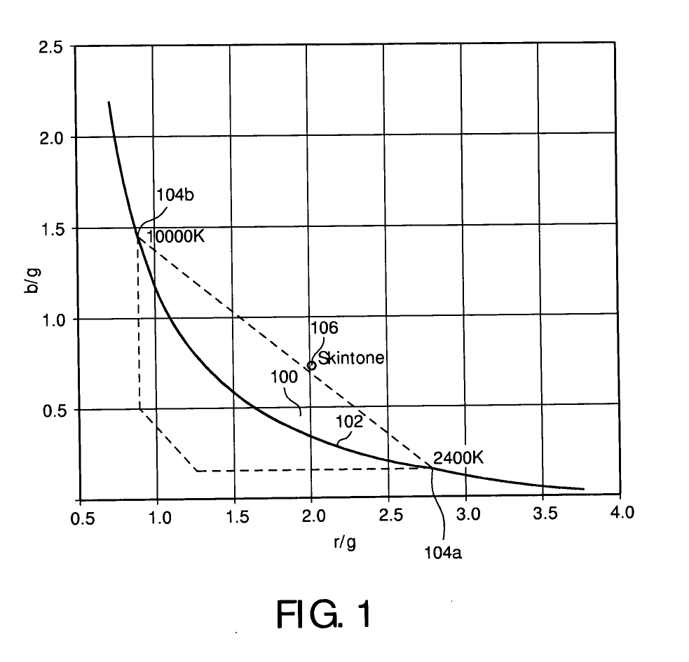

In one known AWB system, and referring to FIG. 1 of the drawings, a very simple LWA 100 is employed which consists of 4 lines and is illustrated in FIG. 1 in the two-dimensional RGB space (with R/G and B/G axes) relative to the black body radiator curve 102 (defining the various color temperatures of the “near white” light sources).

White balancing is performed when the ratios R/G and B/G fall within the LWA 100. More specifically, a determination is made whether the ratios R/G and B/G obtained from actual picture data are within the LWA and, if so, the white balance measurement includes that specific picture data in the average white calculation. When a complete frame is measured, the gain levels of the color signals R and B are being calculated on the basis of the average white calculation. These gain levels can be used in the next frame or, in a two-part situation, on the actual picture data. As a result, the output signal levels of the three primary color signals R, G and B from respective amplifiers are set equal to each other, i.e. R:G:B=1:1:1 when the camera is focused on a “near white” subject.

However, this simple LWA 100 has two main drawbacks, namely:

(i) at both ends of the LWA 100 the area is wedge-shaped and, since there are always tolerances on the color filter array transfer function and on the IR filter of the camera, the area at these ends is too narrow, so the end points 104a, 104b have to be at a lower temperature at one end 104a and a higher temperature at the other end 104b than is actually required.
(ii) since the black body radiator curve 102 is not straight, as opposed to the LWA lines, a lot of extra colors are spuriously taken into account for the mean R, G and B accumulators. In particular, skin tones often fall within the defined LWA, which disturbs the AWB measurement system. In the example illustrated in FIG. 1, the defined skin tone value 106 is just at the edge of the LWA area, but again, due to tolerances in the color filter array and IR filter transfer functions and different light sources, such skin tones will often fall within the LWA 100.

An AWB control system is described in European Patent Application No. EP-A-0400606 in which a black body radiation curve is generated using measurements obtained when viewing a “white” camera subject under a light source with various color temperatures and a tracking range is provided on each side of the black body radiation curve which defines the LWA.

However, it is necessary to obtain the measurements for, and calibrate, the black body radiation curve at the manufacturing stage of the system, and to store the parameters and measurements in a permanent memory means.

We have now devised an improved arrangement and it is an object of the present invention to provide a system for performing automatic white balance control in a color digital image capture device, a color digital image capture device including such a system, and a corresponding method for performing automatic white balance control, in which the real shape of the black body radiator curve, determined during system operation, as opposed to manufacture, is used to define a tighter LWA around the black body radiator curve, giving better automatic white balance control results.

Thus, in accordance with the present invention, there is provided a system for performing automatic white balance control in respect of a color digital image, the system being arranged and configured, in respect of an image, to:

a) define a predetermined color space in which the black body radiator curve within at least two domains of said color space is known; and
b) approximate said black body radiator curve by applying an approximation function dependent on said at least two domains of said color space and shifting said approximated curve to the left and/or right to define a limited white area around said black body radiator curve within said color space;

the system further comprising means for determining if the color values of the pixels within a captured image fall within said limited white area and, if so, perform automatic white balancing in respect thereof.

The present invention extends to a circuit for defining a limited white area for use in an automatic white balancing system as defined above, wherein the location of the black body radiator curve within at least two domains of said predetermined color space is known, the circuit comprising means for approximating said black body radiator curve by applying an approximation function dependent on said at least two domains of said color space and shifting said approximated curve to the left and/or right to define a limited white area around said black body radiator curve within said color space.

The present invention further extends to a color digital image capture device, comprising an image sensor for capturing an image frame comprising a plurality of pixels representative of a scene within the field of view of said image capture device, and an automatic white balance control system as defined above for performing automatic white balance control in respect of image frames captured by said image sensor.

Once the color space has been defined and is known, the precise location of the black body radiator curve is also known.

Thus, the limited white area is clearly defined by a formula (or approximation function) which fits substantially exactly to the black body radiator curve in at least two (preferably the r/g and b/g) domains, the formula being a function of those two domains. The function is then offset to the left and/or right (and preferably both) to define the limited white area around the black body radiator curve. No calibration at the time of manufacture is required, and no permanent memory to store respective parameters and measurements for automatic white balancing is necessary.

The resultant limited white area can be used provided a color matrix is employed beforehand, in order to transform the color space (or color gamut) of the CCD or CMOS sensor of the image capture device to a known color space (e.g. sRGB or EBU). In this known color space, the exact location of the black body radiator curve is known, and therefore the above-mentioned formula can be used to form the LWA detection region around it.

A preferred approximation function for the r/g and b/g domain for the black body radiator curve is:

$$\frac{b}{g} = \frac{{C}_{1} \cdot \frac{r}{g} + {C}_{2}}{\frac{r}{g} + {C}_{0}}$$

where C₀, C₁ and C₂ are coefficients which partially define the shape of the limited white area.

In addition, because a known color space is employed, the color temperature of the light source illuminating the scene can be determined (and changes therein can be taken into account), which further enhances the ability of the present invention to preserve the representation of the captured scene as close to that perceived by a human observer. Conventional automatic white balancing systems tend to control to R=G=B=1, as stated above, which corresponds to a certain predetermined white, e.g. D6500. This has the disadvantage of making some scenes look “cold”, when a human observer has a warmer impression of the scene. However, in the system of the present invention, means are preferably provided for measuring the white point of a captured image, e.g. 3200K, and means may then beneficially be provided for mapping the measured white point to a new white point via a transform function (without calibration being required). For example, measured 3200K scenes may be white balanced to 5000K, 4000K scenes may be white balanced to 5500K, 5000K scenes may be white balanced to 6500K, 5000K to 65000K, with everything above 6500K being left unchanged.

A fast and accurate algorithm is proposed for determining a scene color temperature from the limited white area determination, which algorithm finds the nearest point from the measured average limited white area color to the black body radiator curve.

In a preferred embodiment, the color value of each pixel of an image frame (or a subset thereof) is determined and only the color values determined to fall within the limited white area is are integrated (or accumulated) for the purposes of the automatic white balance control process, whereas in conventional systems all of the R, G and B values of all of the pixels are integrated. The restricted integration proposed in respect of a preferred embodiment of the present invention tends to yield better results relative to the prior art. Consider, for example, the case where there is a lot of red in a captured image, but there is also a white part. In the case of prior art arrangements, in which all R, G and B values (within a frame) are first integrated (i.e. accumulated) before it is determined whether or not the resultant average white falls within the LWA, the white part of the image would not be sufficient to offset the large amount of accumulated red, so that the resultant integrated values would fall outside of the LWA, thereby indicating that no automatic white balance is possible. This problem is, however, overcome if the color value of each pixel is individually compared against the LWA and then only those values falling within the LWA are integrated for the purposes of the automatic white balance process.

In a specific exemplary embodiment of the present invention, the equation any pixel may have to meet to fall within the limited white area may be as set out below, expressed in R G B:

R·(B+C₁·G)≧G·(C₀·B+C₂·G)

[symbol]

R·(B+C₄·G)≦G·(C₃·B+C₅·G)

[symbol]

B≦C₆·G

[symbol]

R≦C₇·G [symbol] F<Y<E

where C₃, C₄ and C₅ are parameters which, in addition to C₀, C₁, and C₂, define the shape of the limited white area, C₆ and C₇ are dependent on the temperature range required to be defined by the limited white area, and are respectively dependent on the highest and lowest color temperatures of the required temperature range, Y is luminance, with E and F being parameters thereof.

Another potential advantage of the present invention is the ability to only employ multipliers (and adders) in its implementation, as opposed to dividers which generally take up more resources (in terms of area and power consumption).

These and other aspects of the present invention will be apparent from, and elucidated with reference to, the embodiments described herein.

Embodiments of the present invention will now be described by way of examples only and with reference to the accompanying drawings, in which:

FIG. 1 is a schematic graphical representation of a predefined limited white area, defined in accordance with the prior art;

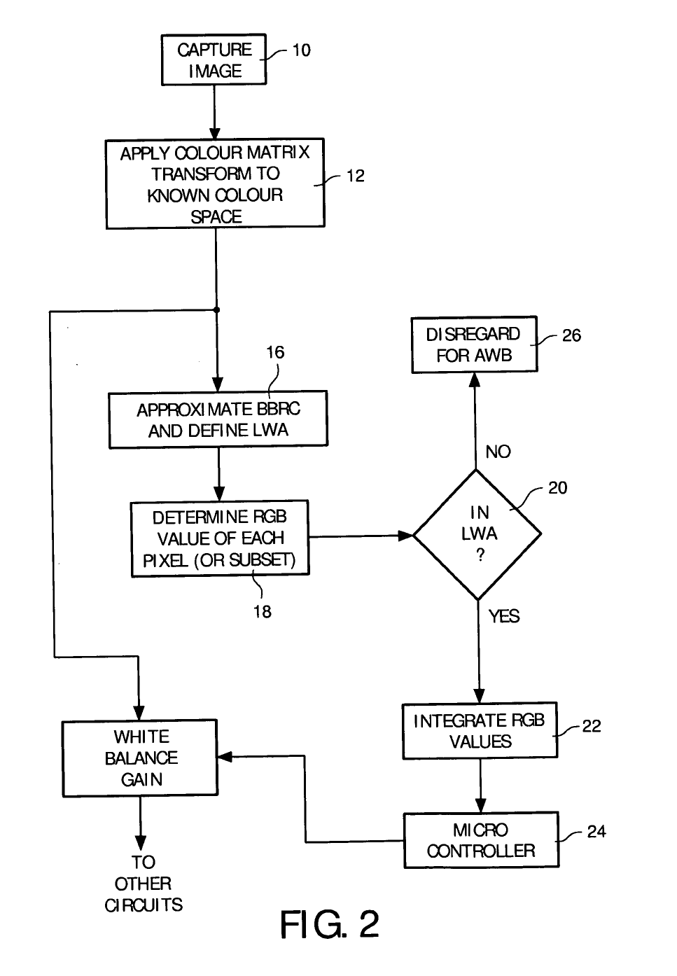

FIG. 2 is a schematic flow diagram illustrating the principle steps in a method of performing automatic white balancing control according to an exemplary embodiment of the present invention;

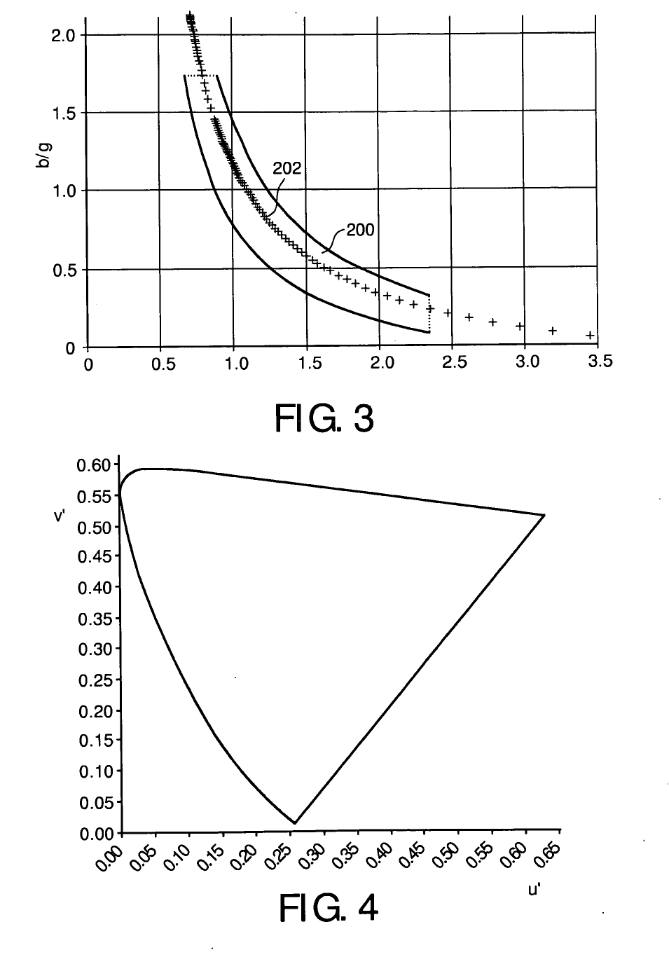

FIG. 3 is a graphical representation in the r/g and b/g domains of a limited white area obtained by a method according to an exemplary embodiment of the present invention;

FIG. 4 is a representation of the limited white area of FIG. 2 in the u′, v′ domains of the CIE chromaticity diagram;

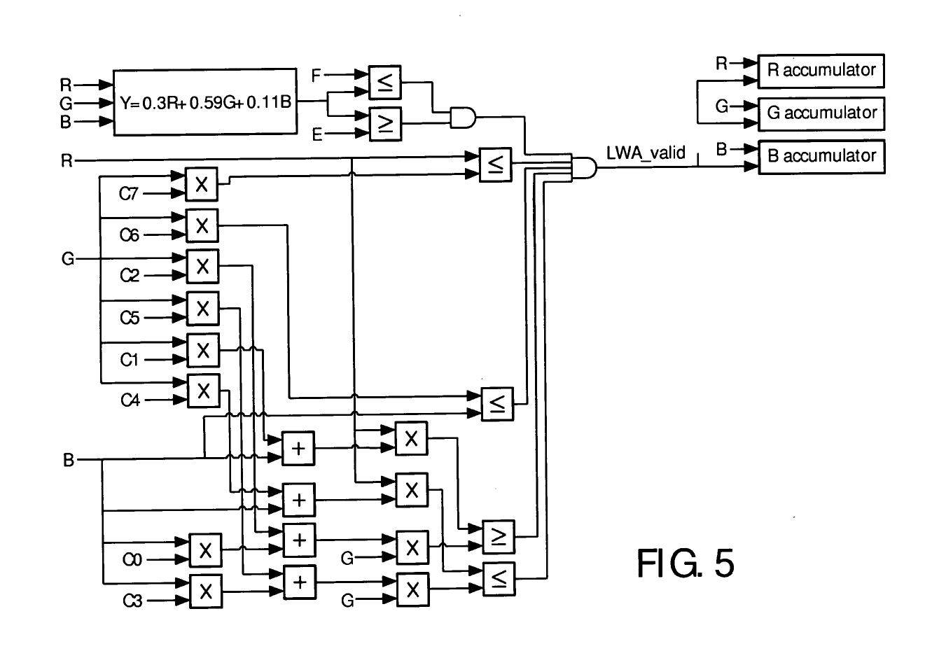

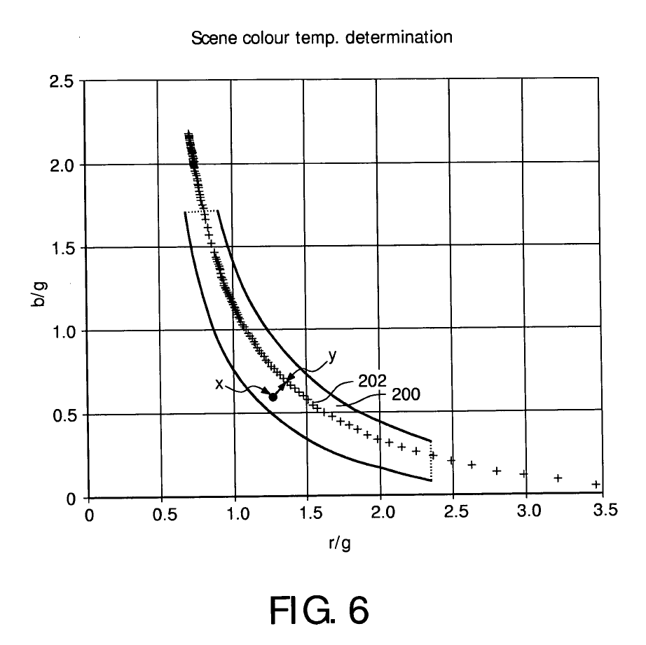

FIG. 5 is a schematic circuit diagram illustrating an exemplary configuration of a system according to an exemplary embodiment of the present invention; and

FIG. 6 is a graphical representation in the r/g and b/g domains of a limited white area, illustrating how the scene color temperature can be determined.

In the automatic white balance system of the following exemplary embodiment of the present invention, a limited white area is defined by a formula which fits almost exactly to the black body radiator curve in the r/g and b/g domain. This formula is a function of r/g and b/g respectively, and is offset to the left and right to define the limited white area (LWA) around the black body radiator.

Referring to FIG. 2 of the drawings, in order to facilitate the definition of the limited white area in the manner described above, first an image frame is captured by the CCD or CMOS sensor of the color digital camera at step 10, and the color space of that sensor is transformed at step 12, using a color matrix transform, to a known color space, such as sRGB or EBU.

As will be well known to a person skilled in the art, a color space is a method by which it is possible to specify, create and visualize color, wherein a color is usually specified using three coordinates or parameters. These parameters describe the position of the color within the color space being used, although they do not actually indicate what the color is (this is dependent on the color space being used). For example, consider that with the three colors red (R), green (G) and blue (B), a lot of other colors can be simulated and, if, within a color space, each of these colors can be assigned a number between 0 and 255, then 256*3 combinations of these colors mean that 16,777,216 colors can be specified within that color space in the format ‘61-153-115’ giving the respective color values of R-G-B. There are many types of color space model known in the art, with the sRGB model (being an international standard) currently being the most widely accepted, although many others are known.

Thus, once the color space of the sensor has been transformed to a known color space, the exact location of the black body radiator curve within that color space is also known. Next, at step 16, a function is employed to approximate the shape of the black body radiator curve, and a very good approximation function for the r/g and b/g domains for the black body radiator curve is:

$$\frac{b}{g} = \frac{{C}_{1} \cdot \frac{r}{g} + {C}_{2}}{\frac{r}{g} + {C}_{0}}$$

and this equation is then also used to define (at step 16) the limited white area, by shifting this function up and down (i.e. to the left and right). As a result, and referring to FIG. 3 of the drawings, a new limited white area (LWA) 200 following the shape of the black body radiator curve 202 is defined, and illustrated in FIG. 3 in the r/g, b/g domain.

In an exemplary circuit implementation of the present invention, as illustrated in FIG. 5 of the drawings, this part of the process may require 12 multipliers, 4 adders and 4 comparators. However, this may be reduced to 10 multipliers, 4 adders and 6 comparators if four straight lines are used to approximately follow the black body radiator curve, or even less if an even less accurate approximation of the curve is used, although it will be apparent to a person skilled in the art that the closer the LWA follows the shape of the black body radiator curve, the more accurate will be the automatic white balancing process. On the other hand, if the AWB process is only performed in respect of every other pixel, say, of a frame, then the number of multipliers could be reduced from 12 to 6 (in the above-mentioned example) by pipelining the multiplications without loss of accuracy. More generally, a subset of the total frame size (defined, for example, by a rectangular window area) can be used to define which pixels are required to be measured in this regard.

A color gamut is the area enclosed by a color space in three dimensions. It is usual to represent the gamut of a color representation system graphically as a range of colors. Often the gamut will be represented in only two dimensions, for example, on a CIE u′v′ chromaticity diagram, and in FIG. 4 of the drawings, the LWA 200 is shown in the u′, v′ domains of such a diagram.

The color value of each pixel in a captured frame is then determined and compared against the LWA (at step 18) and only if, at step 20, the color value of a pixel is determined to fall within the LWA, that pixel is employed within the automatic white balancing (AWB) process denoted at step 24 and the respective R, G and B values are integrated (accumulated) for this purpose. Otherwise, the pixel is disregarded for the AWB process.

It will be appreciated that any suitable (known) method of actually performing the automatic white balancing may be employed once it has been determined which pixels have color values falling within the defined LWA, and the present invention is not intended to be limited in this regard.

In this exemplary embodiment of the present invention, the conditions required to be met by the RGB values of a pixel to be determined to fall within the defined LWA, expressed in R G B, is given below:

R·(B+C₁·G)≧G·(C₀·B+C₂·G)

[symbol]

R·(B+C₄·G)≦G·(C₃·B+C₅·G)

[symbol]

B≦C₆·G

[symbol]

R≦C₇·G [symbol] F<Y<E

In an exemplary circuit implementation, two additional comparators may be used to exclude low and high light areas, which are (historically) defined as parameters E and F of the luminance signal Y.

Parameters C₀, C₁, C₂, C₃, C₄ and C₅ employed in Equations 1 and 2 define the shape of the LWA and are, in principle fixed. In principle and, as will be apparent to a person skilled in the art, defining the curved shape of the LWA is relatively simple, as only two lines actually define the two end points of the area, the rest of the area generally remains the same.

In an exemplary implementation of the present invention, therefore, the fixed parameters may be calculated as:

C₀=0.3119

C₁=−0.2594

C₂=0.8008

C₃=0.3119

C₄=0.2471

C₅=1.2344

The other two parameters C₆ and C₇ are dependent on the desired color temperature range to be covered by the LWA, and are respectively dependent on the highest and lowest color temperatures of that range. Both color temperatures are preferably programmable. C6 and C₇ may be determined from a table which contains scene temperatures from 2000K to 75000K vs r/g and b/g coordinates. This table may be calculated from Planck's well-known black body radiator formula, subsequently integrated over the multiplied CIE x, y, z standard human observer curves, giving X, Y, Z values, subsequently transformed to the sRGB color space with the (well known) XYZ→sRGB 3×3 matrix. These concepts will be known to a person skilled in the art, and will not be discussed in any further detail herein. In an exemplary embodiment, the lowest temperature should be programmable from 2000K to 3500K in steps of, say, 100K. In the same exemplary embodiment, the highest temperature should be programmable from 7000K to 22000K in steps of 1000K.

Because a known color space is employed, the color temperature of the light source illuminating the scene can be determined (and changes therein can be taken into account), which further enhances the ability of the system to preserve the representation of a captured scene as close to that perceived by a human observer. Referring to FIG. 6, the average white point X of a captured image can be measured from the CWA algorithm, and the scene color temperature can be determined by first finding the nearest point Y on the black body radiator curve 202. Once this nearest point has been located, the color temperature can be determined using the above-mentioned table in reverse.

The write registers employed in an exemplary implementation of the invention (and a brief description of the respective data held therein) may comprise, for example:
C₀, C₃ 5 bits registers for the limited white area coefficients
C₁, C₄, C₆ 6 bits registers for the limited white area coefficients
C₂, C₅, C₇ 7 bits registers for the limited white area coefficients
E 8 bits register, maximum luminance value for LWA measurement
F 8 bits register, minimum luminance value for LWA measurement

In theory, the proposed automatic white balance system could be used in the analog domain, although in the above example it is employed solely in the digital domain because of the nature of the calculations and the fact that it is easier to implement and maintain it in the digital domain. The proposed automatic white balance system is applicable for use in a digital image capture device and image processing software packages, e.g. photograph editing packages and the like.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1-9. (canceled)

10. A system for performing automatic white balance control in respect of a color digital image, the system being arranged and configured, in respect of an image, to:
define (12) a predetermined color space in which the black body radiator curve (202) within at least two domains of said color space is known; and
approximate (16) said black body radiator curve (202) by applying an approximation function dependent on said at least two domains of said color space and shifting said approximated curve to the left and/or right to define a limited white area (200) around said black body radiator curve (202) within said color space;
the system further comprising means for determining (18) if the color values of the pixels within a captured image fall within said limited white area and, if so, perform (24) automatic white balancing in respect thereof.

11. A system according to claim 10, wherein said at least two domains include the r/g and b/g domains.

12. A system according to claim 10, wherein said approximate function is an approximation function for the r/g and b/g domain for the black body radiator curve (202), of the form:
$$\frac{b}{g} = \frac{{C}_{1} \cdot \frac{r}{g} + {C}_{2}}{\frac{r}{g} + {C}_{0}}$$
where C₀, C₁ and C₂ are coefficients which partially define the shape of the limited white area (200).

13. A system according to claim 10, comprising means for measuring the white point of a captured image.

14. A system according to claim 13, comprising means for mapping the measured white point to a new white point via a transform function.

15. A system according to claim 10, wherein the equation a pixel has to meet to fall within the limited white area (200) is expressed, in R. G and B as:
R·(B+C₁·G)≧G·(C₀·B+C₂·G) [symbol]
R·(B+C₄·G)≦G·(C₃·B+C₅·G) [symbol]
B≦C₆·G [symbol]
R≦C₇·G [symbol] F<Y<E
where C₃, C₄ and C₅ are parameters which, in addition to C₀, C₁ and C₂, define the shape of the limited white area, C₆ and C₇ are dependent on the temperature range required to be defined by the limited white area, and are respectively dependent on the highest and lowest color temperatures of the required temperature range, Y is luminance, with E and F being parameters thereof.

16. A circuit for defining a limited white area (200) for use in an automatic white balancing system according to claim 10, wherein the location of the black body radiator curve (202) within at least two domains of said predetermined color space is known, said circuit comprising means for approximating said black body radiator curve (202) by applying an approximation function dependent on said at least two domains of said color space and shifting said approximated curve to the left and/or right to define a limited white area (200) around said black body radiator curve (202) within said color space.

17. A color digital image capture device, comprising an image sensor for capturing an image frame comprising a plurality of pixels representative of a scene within the field of view of said image capture device, and an automatic white balance control system according to claim 10, for performing automatic white balance control in respect of image frames captured by said image sensor.
